(19) United States
(12) Patent Application Publication
(10) Pub. No.: US 2005/0054552 A1
(43) Pub. Date: Mar. 10, 2005

(54) Detergent for metallic product

(76) Inventors: Jiro Sakurai, Osaka-shi (JP); Takeshi Sugimoto, Habikino-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/494,267

(22) PCT Filed: Nov. 9, 2001
(86) PCT No.: PCT/JP01/09824

(51) Int. Cl. C11D 1/00

(52) U.S. Cl. 510/492

(57) ABSTRACT

A cleaning agent of sulfamic acid-hydroxycarboxylic acid system is provided, which has the capability of preventing metal elution from metal products to be cleaned and hydrogen embrittlement of the metal products. This cleaning agent comprises sulfamic acid and at least one of hydroxycarboxylic acids, and a compounding ratio (weight ratio) of sulfamic acid: at least one of hydroxycarboxylic acids is (60˜95):(40˜5), and preferably (80˜95):(20˜5). In particular, when citric acid and malic acid are used as the hydroxycarboxylic acids, and a compounding ratio (weight ratio) of sulfamic acid:citric acid:malic acid is (80˜95):(10˜2.5):(10˜2.5), it is possible to provide excellent performance in preventing metal elution and hydrogen embrittlement as well as high detergency.

### TECHNICAL FIELD

The present invention relates to a cleaning agent for metal products, and particularly a cleaning agent of sulfamic acid-hydroxycarboxylic acid system, which has excellent detergency and the capability of preventing metal elution and hydrogen embrittlement of metal when cleaning metal products with adhered calcium compounds.

### BACKGROUND ART

In the past, when a water-insoluble organic material generated by the decomposition of food residua adheres to the inner wall of a kitchen drainpipe, or a calcium compound resulting from the decomposition of human waste such as urine adheres to the inner wall of a lavatory drainpipe, clogging of those drainpipes has come into a problem.

As effective chemicals having the capability of removing such an extraneous matter (so-called scale) from the drainpipes, there are strong inorganic acids such as hydrochloric acid and sulfuric acid. However, these chemicals lead to corrosion of the drainpipe material. In addition, there is a problem that wastewater resulting from cleaning causes environment pollution.

On the other hand, the adhered scale can be physically removed from the drainpipes. However, such a cleaning operation is dirty and hard. Particularly, when the drainpipes are intricately arranged in a narrow space, disassembling/cleaning operations will become a long-haul hard operation.

To solve these problems caused by use of the strong acidic chemicals, a cleaning agent of sulfamic acid-hydroxycarboxylic acid system having a high scale removing capability receives widespread attention. For example, Japanese Patent Early Publication No. 2000-63890 discloses a removing agent, which is a composition containing at least one sulfamic acid and at least one of hydroxycarboxylic acids such as malic acid and citric acid. This cleaning agent is effective to remove the scale adhering to drainpipes and calcified tartar, which had been removed by use of inorganic acid or inorganic alkali. In addition, there is an advantage that the cleaning agent can be safely used as a tractable, eco-friendly cleaning agent.

On the other hand, Japanese Patent Early Publication No. 2000-64069 discloses a scale removing agent containing hydroxycarboxylic acid and sulfamic acid as essential components. As the hydroxycarboxylic acid, for example, glycolic acid or malic acid is preferably used. In addition, it is disclosed that a preferable compounding ratio (weight ratio) of sulfamic acid:hydroxycarboxylic acid is 5:95˜30:70. This removing agent demonstrates excellent property of dissolving the scale (typically, calcium carbonate) adhered to dialysis machines and so on. In addition, there is an advantage that an amount of metal corrosion becomes smaller as compared with the case of using a conventional acidic cleaning agent. Moreover, this removing agent is odor free, and has improved safety against human body and environment.

Thus, the cleaning agent of sulfamic acid-hydroxycarboxylic acid system is effective to clean an object with adhered calcium compounds. However, irrespective of organic acid or inorganic acid, when most of acids contact a metal, hydrogen is generated. When the generated hydrogen is adsorbed in the metal, so that atomic hydrogen is pooled in grain boundaries, or diffuses into vacancies, cracks may occur in the metal. That is, hydrogen embrittlement of metal is caused. On the other hand, it is known that sulfamic acid has a strong property of causing elution of metal ions when contacting the metal. The above-described cleaning agent and removing agent are excellent in the scale removing capability and the safety against to human body and environment. However, they are susceptible to improvement in terms of decreasing the metal elution from the object to be cleaned and preventing the hydrogen embrittlement of the object. In particular, with respect to the removing agent disclosed in Japanese Patent Early Publication No. 2000-64069, since an amount of hydroxycarboxylic acid is larger than the amount of sulfamic acid, the hydrogen embrittlement may cause a serious problem depending on material of the object to be cleaned.

### SUMMARY OF THE INVENTION

Therefore, a primary concern of the present invention is to provide a cleaning agent of sulfamic acid-hydroxycarboxylic acid system, which demonstrates excellent performance in preventing hydrogen embrittlement of metal and metal elution as well as high detergency in the case of cleaning metal products with adhered calcium compounds.

That is, the cleaning agent of the present invention comprises sulfamic acid and at least one of hydroxycarboxylic acids, which is characterized in that a compounding ratio (weight ratio) of sulfamic acid:at least one of hydroxycarboxylic acids is (60˜95):(40˜5), and preferably (80˜95):(20˜5).

In particular, when citric acid and malic acid are used as the hydroxycarboxylic acids, and a weight ratio of sulfamic acid:citric acid:malic acid is (80˜95):(10˜2.5):(10˜2.5), the cleaning agent provides the maximum performance in preventing both of hydrogen embrittlement and metal elution as well as excellent detergency.

Further characteristics of the present invention and effects brought thereby will be understood from the best mode for carrying out the invention described below in details.

### BEST MODE FOR CARRYING OUT THE INVENTION

As sulfamic acid used in the cleaning agent of the present invention, for example, it is possible to use sulfamic acid, N-alkyl and N-allyl derivatives of amidosulfonic acid or the like.

On the other hand, hydroxycarboxylic acid is a generic name of a compound containing alcoholic hydroxyl group and carboxyl group in its molecular structure. For example, it is possible to use at least one selected from malic acid, citric acid, glycolic acid, lactic acid, tartaric acid, hydracrylic acid, α-hydroxy-butyric acid, glyceric acid, tartronic acid, salicylic acid, meta-hydroxy benzoic acid, para-hydroxy benzoic acid, gallic acid, mandelic acid and tropic acid. In particular, it is possible to use malic acid and/or citric acid.

In the present invention, a compounding ratio of sulfamic acid and hydroxycarboxylic acid is very important. That is, it is preferred that the compounding ratio (weight ratio) of sulfamic acid:hydroxycarboxylic acid is (60˜95):(40˜5), and more preferably (80˜95):(20˜5). When the compounding ratio of the hydroxycarboxylic acid is more than 40, the detergency can be maintained, but hydrogen embrittlement of metal of the object to be cleaned may be caused. On the other hand, when the compounding ratio of the hydroxycarboxylic acid is less than 5, detergency of the cleaning agent of sulfamic acid-hydroxycarboxylic acid system deteriorates, and elution amounts of metal ions are considerably increased by the excessive amount of sulfamic acid.

In particular, it is preferred that citric acid and malic acid are used as the hydroxycarboxylic acids, and a compounding ratio (weight ratio) of sulfamic acid:citric acid:malic acid is (80˜95):(10˜2.5):(10˜2.5). In this case, it is also preferred that the amount of citric acid is equal to the amount of malic acid. As shown in the following Examples, this cleaning agent of the present invention demonstrates remarkably improved performance in detergency and the capability of preventing metal elution from the object to be cleaned and hydrogen embrittlement of the object.

### EXAMPLES

A cleaning agent for metal products of the present invention is explained below in details according to Examples.

### Examples 1 to 7 and Comparative Example 1 to 5

(1) Preparation of Cleaning Solution According to compounding amounts listed in Table 1, sulfamic acid, citric acid and malic acid were mixed to prepare a cleaning agent. Then, a required amount of water was added to the cleaning agent to obtain a 10% aqueous solution thereof. The thus obtained aqueous solutions were used as cleaning solutions of Examples 1 to 7 and Comparative Examples 1 to 5.

TABLE 1

| | Sulfamic acid | Citric acid | Malic acid |
|---|---|---|---|
| | Weight % | | |
| Example 1 | 90 | 5 | 5 |
| Example 2 | 85 | 7.5 | 7.5 |
| Example 3 | 85 | 15 | 0 |
| Example 4 | 85 | 0 | 15 |
| Example 5 | 80 | 10 | 10 |
| Example 6 | 70 | 15 | 15 |
| Example 7 | 60 | 20 | 20 |
| Comparative Example 1 | 100 | 0 | 0 |
| Comparative Example 2 | 10 | 0 | 90 |
| Comparative Example 3 | 20 | 40 | 40 |
| Comparative Example 4 | 40 | 60 | 0 |
| Comparative Example 5 | 0 | 100 | 0 |

(2) Detergency

500 ml of the obtained cleaning solution was put in a beaker, and then a required amount of calcium carbonate (solid) was added to the cleaning solution. While agitating it slowly (approximately 30 rotations per minute), an elution amount of calcium carbonate was measured at every predetermined time. Results are shown in Table 2.

TABLE 2

| | Elapsed time from the start of test | | | |
|---|---|---|---|---|
| | 5 min. | 10 min. | 15 min. | 20 min. |
| | Elution amount (g) | | | |
| Example 1 | 12 | 20 | 24 | 29 |
| Example 2 | 11 | 18 | 20 | 22 |
| Example 3 | 11 | 18 | 20 | 22 |
| Example 4 | 11 | 18 | 20 | 22 |
| Example 5 | 10 | 17 | 18 | 20 |
| Example 6 | 10 | 17 | 18 | 20 |
| Example 7 | 10 | 15 | 17 | 19 |
| Comparative Example 1 | 15 | 25 | 30 | 40 |
| Comparative Example 2 | 5 | 10 | 12 | 15 |
| Comparative Example 3 | 5 | 10 | 12 | 15 |
| Comparative Example 4 | 7 | 12 | 15 | 18 |
| Comparative Example 5 | 3 | 7 | 9 | 10 |

(3) Performance in Preventing Metal Elution

To evaluate the degree of corrosion of an object to be cleaned caused by the cleaning solution, elution amounts of titanium ions from the object were measured. As the object, a steel plate having sizes of 15 cm×15 cm×6 mm (JIS SS41: rolled steel plate for general structure) was used. The test temperature is 20° C. The elution amounts of titanium ions were measured by Inductively Coupled Plasma Emission Spectrochemical Analysis after the elapse of each of 1 hour, 24 hours, 48 hours and 120 hours from the start of the test. Results are shown in Table 3.

TABLE 3

| | Elapsed time from the start of test | | | |
|---|---|---|---|---|
| | 1 hour | 24 hours | 48 hours | 120 hours |
| | Elution amounts of | | | |
| | titanium ions (μg/ml) | | | |
| Example 1 | <0.1 | <0.1 | <0.1 | <0.1 |
| Example 2 | <0.1 | <0.1 | <0.1 | <0.1 |
| Example 3 | <0.1 | 0.18 | 0.25 | 0.30 |
| Example 4 | <0.1 | 0.16 | 0.21 | 0.25 |
| Example 5 | <0.1 | 0.15 | 0.20 | 0.22 |
| Example 6 | <0.1 | 0.16 | 0.21 | 0.25 |
| Example 7 | <0.1 | 0.16 | 0.21 | 0.25 |
| Comparative Example 1 | <0.1 | 0.30 | 0.40 | 0.55 |
| Comparative Example 2 | <0.1 | <0.1 | <0.1 | <0.1 |
| Comparative Example 3 | <0.1 | <0.1 | <0.1 | 0.10 |
| Comparative Example 4 | <0.1 | <0.1 | <0.1 | 0.15 |
| Comparative Example 5 | <0.1 | <0.1 | <0.1 | <0.1 |

(4) Performance in Preventing Hydrogen Embrittlement

To evaluate hydrogen embrittlement of an object to be cleaned caused by the cleaning solution, a titanium test specimen was dipped for 1 week in each of the cleaning solutions of Examples 1 to 7 and Comparative Examples 1 to 5. Subsequently, a stress loading test of repeatedly applying a stress load to the respective test specimen was performed. The total number of the stress loads repeatedly applied until a crack occurs in the test specimen was counted. As the test specimen, a titanium plate having the size of 2 mm (thickness)×20 mm (width)×100 mm (length) was used. In this stress loading test, the titanium plate dipped for 1 week in the cleaning solution was fixed at its one end in a cantilever fashion. A round bar having a diameter of 10 mm was used as a pushrod. Under conditions that a pressing force is approximately 2 kg, stroke width is 2 mm, test temperature is 20° C., and a pressing frequency is 1 time/second, the stress load was repeatedly applied at a location of the titanium specimen, which is distant from the other end of the titanium specimen by about 25 mm. The test was continued until the occurrence of a crack in the titanium plate is confirmed by visual check. Therefore, it means that as the total number of stress loads needed for the occurrence of the crack is smaller, an influence of hydrogen embrittlement on material deterioration of the titanium plate becomes larger. In other words, it means that as the total number of stress loads needed for the occurrence of the crack is larger, the cleaning solution has a higher capability of preventing hydrogen embrittlement. Test results are shown in Table 4.

TABLE 4

| | The total number of stress loads |
|---|---|
| | needed for the occurrence of a crack |
| Example 1 | 3525 |
| Example 2 | 3530 |
| Example 3 | 3550 |
| Example 4 | 3510 |
| Example 5 | 3580 |
| Example 6 | 2815 |
| Example 7 | 2803 |
| Comparative Example 1 | 3550 |
| Comparative Example 2 | 1800 |
| Comparative Example 3 | 1815 |
| Comparative Example 4 | 2500 |
| Comparative Example 5 | 1800 |

(5) Results

As understood from the above experimental results, when using the cleaning agent (Comparative Example 1) of 100% of sulfamic acid, it is possible to avoid the problem of hydrogen embrittlement. However, since the elution amounts of metal (titanium) ions are extremely large, this cleaning agent is disqualified. In addition, when using the cleaning agent (Comparative Example 5) of 100% of citric acid, the amounts of metal elution decrease. However, the detergency considerably lowers, and hydrogen embrittlement easily occurs. Therefore, this cleaning agent is disqualified too because it does not meet the purpose of the present invention. Moreover, with respect to the cleaning agents of sulfamic acid-hydroxycarboxylic acid system of Comparative Examples 2 to 4, which have different in composition from the present invention, they demonstrate a certain level of detergency and a reduction in metal elution. However, due to the occurrence of hydrogen embrittlement, the crack occurred when the total number of stress loads is relatively small. These results indicate that the compositions of Comparative Examples can not provide the cleaning agent excellent in all of the following three properties, (1) detergency, (2) capability of preventing metal elution, and (3) capability of preventing hydrogen embrittlement.

On the contrary, the results of Examples 1 to 7 show that the cleaning agent having the capability of preventing hydrogen embrittlement and metal elution, and providing high detergency can be obtained in the composition range of the present invention. In particular, when the cleaning agent is prepared according to the composition of Example 1 or 2 such that the cleaning agent contains a large amount (80% or more) of sulfamic acid and the balance of citric acid and malic acid, and the amount of citric acid is equal to the amount of malic acid, approximately 70% or more of the detergency of 100% of sulfamic acid can be maintained, and the elution amounts of metal ions become less than ⅕. In addition, with respect to the capability of preventing hydrogen embrittlement, it is comparable to 100% of sulfamic acid.

Therefore, to improve the poor capability of preventing metal elution that is the worst weakness of 100% of sulfamic acid, while maintaining high detergency and the capability of preventing hydrogen embrittlement brought by 100% of sulfamic acid, it is particularly preferred to use the cleaning agent of Example 1 or 2, i.e., the cleaning agent having the compounding ratio of sulfamic acid:citric acid:malic acid of (80˜95):(10˜2.5):(10˜2.5).

Industrial Applicability

As described above, the cleaning agent for metal products of the present invention comprising sulfamic acid and at least one of hydroxycarboxylic acids, which is characterized in that the compounding ratio (weight ratio) of sulfamic acid:at least one of hydroxycarboxylic acids is (60˜95):(40˜5), and preferably (80˜95):(20˜5), demonstrates excellent performance in detergency and the capability of preventing both of hydrogen embrittlement of metal and metal elution from an object to be cleaned.

In industries regarding “service with safety” as important such as airline, shipping and railway, when selecting a cleaning agent for airplanes, ships and railcars, they give attention to the problem of hydrogen embrittlement that may become a cause of metal fatigue. On the other hand, to address congested schedules, selecting the cleaning agent with high detergency is also important to save time needed for cleaning and maintenance. As the cleaning agent satisfying such severe needs, for example, it is recommended to use the cleaning agent of Example 1 or 2, in which citric acid and malic acid are used as the hydroxycarboxylic acid, and the compounding ratio of sulfamic acid:citric acid:malic acid is (80˜95):(10˜2.5):(10˜2.5).

Therefore, the cleaning agent for metal products of the present invention can be used in various application fields regarding hydrogen embrittlement and metal elution as problems to be solved in addition to the airplanes, ships and railcars, and has a wide industrial applicability as an eco-friendly cleaning agent having high detergency.

1. A cleaning agent for metal products comprising sulfamic acid and at least one of hydroxycarboxylic acids, wherein a compounding ratio (weight ratio) of sulfamic acid: said at least one of hydroxycarboxylic acids is (60˜95):(40˜5).

2. The cleaning agent as set forth in claim 1, wherein the compounding ratio (weight ratio) of sulfamic acid: said at least one of hydroxycarboxylic acids is (80˜95):(20˜5).

3. The cleaning agent as set forth in claim 1, wherein said at least one of hydroxycarboxylic acids is at least one of citric acid and malic acid.

4. The cleaning agent as set forth in claim 1, wherein said at least one of hydroxycarboxylic acids is citric acid and malic acid, and a compounding ratio (weight ratio) of sulfamic acid:citric acid:malic acid is (80˜95):(10˜2.5):(10˜2.5).

5. An aqueous solution for cleaning obtained by diluting the cleaning agent as set forth in claim 1 with water.
